(19) United States
(12) Patent Application Publication
(10) Pub. No.: US 2019/0259026 A1
(43) Pub. Date: Aug. 22, 2019

(54) Anonymous Event Processing Using Secure Digital Information Vault

(71) Applicant: Bank of America Corporation, Charlotte, NC (US)

(72) Inventor: Ricki A. Beye, Highland Beach, FL (US)

(21) Appl. No.: 15/902,381

(22) Filed: Feb. 22, 2018

(51) Int. Cl. G06Q 20/38; H04L 9/32; G06F 21/62; G06Q 20/10

(52) U.S. Cl. CPC G06Q 20/383; H04L 9/3213; H04L 2209/38; G06Q 20/10; G06F 21/6254

(57) ABSTRACT

Arrangements for anonymously processing events are provided. In some examples, a computing platform, may receive a request to process an event. The computing platform may extract data from the received request and, based on the extracted data, may generate a single-use event processing token that may include data mapping an anonymous event processing source to a user event processing source stored, for example, in a secure digital information vault. The mapping may be exclusively discernable to the computing platform. The single-use event processing token may be transmitted to a computing system and the event may be processed. Processing the event may include the computing system generating an instruction to process the event and transmitting the instruction to the computing platform. The event may be processed using the anonymous event processing source. After processing the event, the computing platform may reconcile the event by transferring funds between the user event processing source and the anonymous event processing source.

### BACKGROUND

Aspects of the disclosure relate to electrical computers and systems. In particular, one or more aspects of the disclosure relate to using anonymous event processing using a secure digital information vault.

Protecting privacy of information and is of the utmost interest to most people and businesses today. However, risks associated with maintaining user information in a secure manner are increasing. Accordingly, it is important to provide increasingly secure and reliable ways to maintain user information.

In addition, many businesses store additional information related to user purchases, costs of purchases, and the like. In some arrangements, this information may be stored without a user even being aware. For instance, a conventional system may process an event using an account of user and may store this information, as well as additional user information (e.g., name, contact information, and the like) and purchase information, and use it to predict user behaviors, generate incentives, and the like. In these conventional arrangements, it is difficult if not impossible for a user to control or maintain private information, such as personal user information.

Some conventional arrangements allow a user to process an event without providing an actual account number. Instead, those arrangements rely on a temporary or other number that maps to the user account number in order to process the event. However, in these examples, user information is still provided to the business and/or the business may be able to access user information, such as a user account, via the temporary account number.

Accordingly, it would be advantageous to provide anonymous event processing which may enable a user to maintain private user information in a secure digital information vault.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with controlling access to personal information, particularly when processing events.

In some examples, a system, computing platform, or the like, may receive a request to process an event. The request may include data associated with the event, such as a unique identifier associated with the event, instructions for processing the event, and the like. In some examples, the system, computing platform, or the like, may extract data from the received request and, based on the extracted data, may generate a single-use event processing token. In some examples, the single-use event processing token may include data mapping an anonymous event processing source to a user event processing source stored, for example, in a secure digital information vault. The mapping may be discernable to the system, computing platform, or the like.

In some arrangements, the single-use event processing token may be transmitted to a computing system and the event may be processed. In some examples, processing the event may include the computing system generating an instruction to process the event and transmitting the instruction to the system, computing system, or the like. The event may be processing using the anonymous event processing source and another unique identifier may be generated indicating that the event was processed.

After processing the event, the system, computing platform, or the like, may reconcile the event by transferring funds between the user event processing source and the anonymous event processing source.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing anonymous event processing functions in accordance with one or more aspects described herein;

FIGS. 2A-2E depict an illustrative event sequence for implementing anonymous event processing functions in accordance with one or more aspects described herein;

FIG. 3 depicts an illustrative method for implementing and using a system to perform anonymous event processing functions, according to one or more aspects described herein;

FIG. 4 illustrates an example user interface that may be generated and used to anonymously process events, according to one or more aspects described herein;

FIG. 5 illustrates another example user interface that may be generated and used to anonymously process events, according to one or more aspects described herein;

FIG. 6 illustrates one example operating environment in which various aspects of the disclosure may be implemented in accordance with one or more aspects described herein; and

FIG. 7 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to using anonymous event processing functions to control access to user information and prevent distribution of user information by maintaining information in a secure digital information vault.

As mentioned above, protecting information and controlling access to information is important to business and individuals alike. Conventional systems and arrangements for processing events require users to provide identifying information (e.g., event processing source information) which can then be stored by the entity processing the event and used to determine or predict user behaviors. Accordingly, arrangements for controlling and minimizing access to user information while processing events may be advantageous.

As discussed herein, a user may register with a secure digital information vault maintained or controlled by an entity (e.g., a financial institution or other entity). The user may, in at least some examples, store sensitive personal information such as name or other identifier, contact information, user event processing sources (e.g., account numbers and the like), government issued photographic identification, and the like. In some examples, additional information associated with other users in a household of the user may be provided. Further information such as credit report, credit score, or the like, may also be provided. This information may be securely stored and accessible, in some examples, only by the entity maintaining the secure digital information vault.

Accordingly, a user may request to process an event (e.g., payment for goods or services) and may transmit a request to an event processing computing platform. The event processing computing platform may extract data from the request and may generate a single-use event processing token which may then be transmitted to a vendor computing system. The single-use event processing token include an anonymous event processing source that may be used to process the event by incorporating data that maps the anonymous event processing source to a user event processing source. The mapping may be discernable or readable by the event processing computing platform. In some examples, the mapping is exclusively discernable or readable by the event processing computing platform. The event may then be processed (e.g., anonymous payment enabled).

After processing the event, the event processing computing platform may reconcile the event by identifying a user event processing source (e.g., via the mapping) and transfer funds from the user event processing source to the anonymous event processing source. This reconciliation may be performed after each event is processed or as a batch process.

Accordingly, by processing the event using the anonymous event processing source, user identifying information is never provided to the vendor computing system, thereby preventing the vendor computing system from storing user information. In addition, the event processing computing platform may in parallel write the event processing details to an anonymous user block chain that stores non-identifiable user information separately from purchase information. Accordingly, if desired, the purchase information may be used, anonymously, to monitor purchases, predict behaviors, and the like based, in at least some examples, only on demographic attributes. In some examples, the event processing details may be written to the anonymous user block chain after an event has been reconciled.

These and various other arrangements will be discussed more fully below.

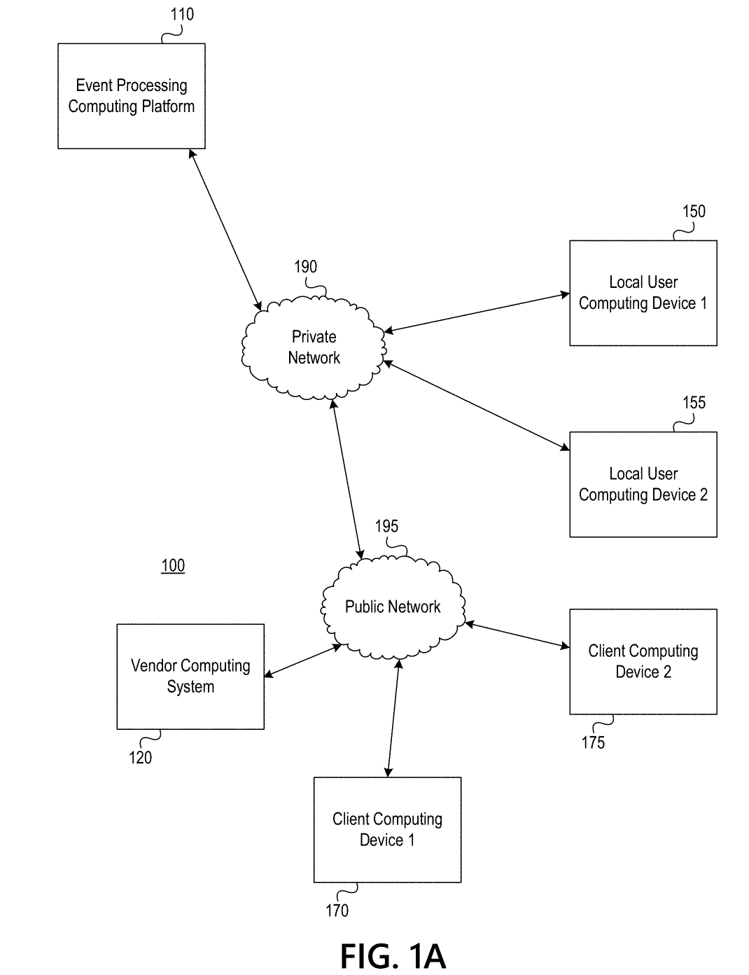

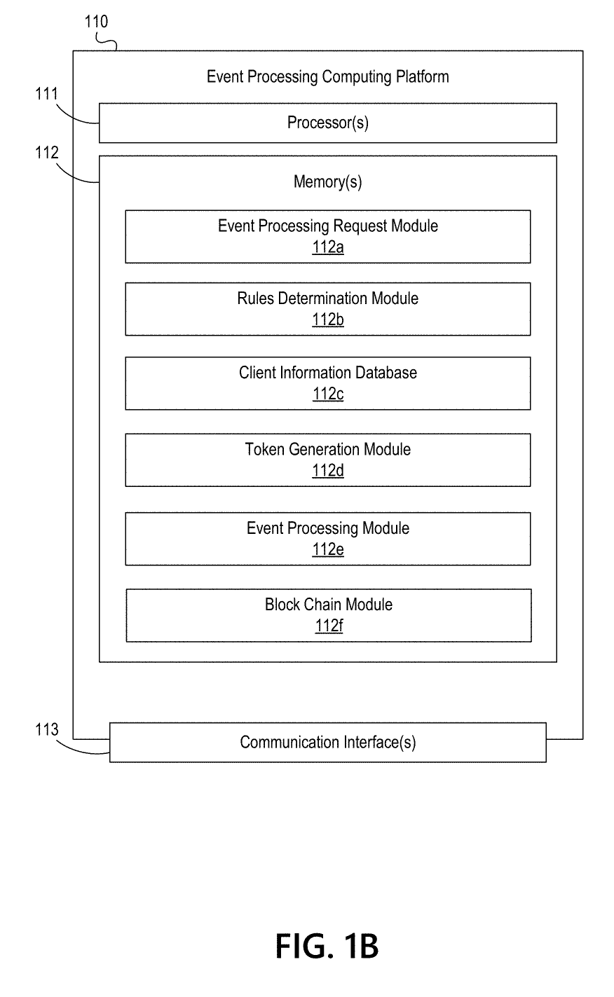

FIGS. 1A and 1B depict an illustrative computing environment for implementing and using a system for anonymously processing events using a secure digital information vault in accordance with one or more aspects described herein. Referring to FIG. 1A, computing environment 100 may include one or more computing devices and/or other computing systems. For example, computing environment 100 may include an event processing computing platform 110, a vendor computing system 120, a first local user computing device 150, a second local user computing device 155, a first client computing device 170, and a second client computing device 175.

Event processing computing platform 110 may be configured to provide anonymous event processing functions. In some examples, a request to process an event may be received from a client computing device (e.g., client computing device 170, 175). In some examples, the request may include data received from a vendor computing system 120. For instance, the request may include instructions for crediting the vendor's account and/or a unique identifier associated with the transaction. The event processing computing platform 110 may extract data from the request and may generate a single-use token that may be transmitted to the vendor computing system 120. In some examples, the single-use token will include information for processing the event, such as an anonymous source from which the event may be processed. The single-use token may include no information identifying a user, event processing source of a user, or the like. In some examples, any information identifying a user, user event processing source, or the like, that may be used to process an event in a conventional arrangement may be identified via a unique mapping (e.g., in the single-use event processing token) of user information to anonymous event processing source information that is discernable only to the event processing computing platform (e.g., an entity associated with, operating or implementing the event processing computing platform 110 and not to the vendor computing system 120).

In some examples, the vendor computing system 120 and event processing computing platform 110 may process the event from an anonymous event processing source. The anonymous event processing source might not include any information identifying a user, user event processing source, or the like. Rather, the anonymous event processing source may include only an entity name and entity event processing information (e.g., the entity implementing the event processing computing platform, maintaining the secure digital information vault, or the like. In some examples, the entity may be a financial institution). For instance, if the event is a purchase of a product, the request to purchase the product may be processed and funds transferred to the vendor computing system 120 in order to complete the purchase may be transferred from an anonymous account (e.g., general entity account), rather than an account associated with the user actually making the purchase.

After processing the event, the event processing computing platform 110 may identify a user event processing source (e.g., based on the unique mapping in the single-use token) and may reconcile the event processing by transferring funds from the identified user event processing source to the anonymous event processing source, or other source. In some examples, this reconciliation may be performed after each event is processed. In other examples, the reconciliation may be performed as a batch process (e.g., multiple events associated with multiple users may be collected and reconciled as a batch process) at predetermined time intervals (e.g., every 24 hours, at 11:00 p.m. eastern each business day, at 1:00 p.m. GMT each day, or the like).

After the event is reconciled, the single-use token may be deactivated, deleted or destroyed in order to prevent any additional use.

Vendor computing system 120 may be any suitable type of event processing computing system used to various different merchants, service providers, or the like. In some examples, the vendor computing system 120 may be a point-of-sale system configured to process events between a user device (e.g., a mobile device of a user, such as a smartphone, tablet computing device, or the like) and the vendor. In some arrangements, vendor computing system 120 may be equipped with near-field communication capabilities in order to detect a client computing device 170, 175, (e.g., a mobile computing device of a user) in order to process an event.

Local user computing device 150, 155 may be configured to communicate with and/or connect to one or more computing devices or systems shown in FIG. 1A. For instance, local user computing device 150, 155 may communicate with one or more computing systems or devices via network 190. In some examples, local user computing device 150, 155 may be used to control aspects associated with anonymously processing events, such as identifying rules associated with events, controlling types of events being processed, controlling aspects associated with writing to an anonymous user block chain, and the like.

The client computing devices 170, 175 may be used to communicate with, for example, event processing computing platform 110, vendor computing system 120, and the like, in order to generate requests to process events, facilitate event processing, receive and display notifications, and the like.

In one or more arrangements local user computing device 150, local user computing device 155, client computing device 170, and/or client computing device 175 may be any type of computing device or combination of devices capable of performing the particular functions described herein. For example, local user computing device 150, local user computing device 155, client computing device 170, and/or client computing device 175 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of local user computing device 150, local user computing device 155, client computing device 170, and/or client computing device 175 may, in some instances, be special-purpose computing devices configured to perform specific functions.

Computing environment 100 also may include one or more computing platforms. For example, and as noted above, computing environment 100 may include event processing computing platform 110. As illustrated in greater detail below, event processing computing platform 110 may include one or more computing devices configured to perform one or more of the functions described herein. For example, event processing computing platform 110 may include one or more computers (e.g., laptop computers, desktop computers, servers, server blades, or the like).

As mentioned above, computing environment 100 also may include one or more networks, which may interconnect one or more of event processing computing platform 110, vendor computing system 120, local user computing device 150, local user computing device 155, client computing device 170, and/or client computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, event processing computing platform 110, local user computing device 150, and local user computing device 155, may be associated with an organization (e.g., a financial institution), and private network 190 may be associated with and/or operated by the organization, and may include one or more networks (e.g., LANs, WANs, virtual private networks (VPNs), or the like) that interconnect event processing computing platform 110, local user computing device 150, and local user computing device 155, and one or more other computing devices and/or computer systems that are used by, operated by, and/or otherwise associated with the organization. Public network 195 may connect private network 190 and/or one or more computing devices connected thereto (e.g., event processing computing platform 110, local user computing device 150, local user computing device 155) with one or more networks and/or computing devices that are not associated with the organization. For example vendor computing system 120, client computing device 170 and/or client computing device 175 might not be associated with an organization that operates private network 190 (e.g., because vendor computing system 120, client computing device 170 and client computing device 175 may be owned, operated, and/or serviced by one or more entities different from the organization that operates private network 190, such as one or more customers of the organization, public or government entities, and/or vendors of the organization, rather than being owned and/or operated by the organization itself or an employee or affiliate of the organization), and public network 195 may include one or more networks (e.g., the internet) that connect vendor computing system 120, client computing device 170 and client computing device 175 to private network 190 and/or one or more computing devices connected thereto (e.g., even processing computing platform 110, local user computing device 150, local user computing device 155).

Referring to FIG. 1B, event processing computing platform 110 may include one or more processors 111, memory 112, and communication interface 113. A data bus may interconnect processor(s) 111, memory 112, and communication interface 113. Communication interface 113 may be a network interface configured to support communication between event processing computing platform 110 and one or more networks (e.g., private network 190, public network 195, or the like). Memory 112 may include one or more program modules having instructions that when executed by processor(s) 111 cause event processing computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of event processing computing platform 110 and/or by different computing devices that may form and/or otherwise make up event processing computing platform 110.

For example, memory 112 may have, store, and/or include an event processing request module 112a. Event processing request module 112a may store instructions and/or data that may cause or enable the event processing computing platform 110 to receive a request to process an event, extract data from the received request, and the like. In some examples, extracted data may include a unique identifier associated with the event, a type of event, an amount of event, a first party to the event (e.g., a user or user device), a second party to the event (e.g., a vendor or service provider), and the like. In some examples, the request may include identification of items associated with the event (e.g., items being purchased) that may be received from the first party or may be collected based on radio frequency identification (RFID) tags associated with event items.

Event processing computing platform 110 may further have, store and/or include a rules determination module 112b. The rules determination module 112b may store instructions and/or data that may cause or enable the event processing computing platform 110 to identify one or more rules for processing an event. For example, based on the data extracted from the event request, the rules determination module 112b may identify one or more rules to implement in processing the event. For instance, in some examples, events above a threshold amount may activate a rule requiring additional authentication information, use of a particular source in processing the event (e.g., either a particular anonymous source or a particular user source), or the like. Various other rules may be implemented without departing from the invention.

Event processing computing platform 110 may further have, store, and/or include a client information database 112c. Client information database 112c may be a secure database that includes information associated with one or more customers or clients, such as name, contact information, unique identifying information, account or other payment source information, and the like. In some examples, the client information database 112c may be or be a part of the secure digital information vault and may securely store user information. In some examples, purchase history data may be stored in the client information database 112c (e.g., list of items associated with each event, determined behaviors of the customer, and the like). In some examples, a generated single-use token may include information mapping an anonymous event processing source to a user event processing source stored in the client information database 112c. In some arrangements, the mapping may be discernable to only the entity implementing the event processing computing platform 110 and not to the first party to the event (e.g., the vendor).

Event processing computing platform 110 may further have, store and/or include a token generation module 112d. Token generation module 112d may store instructions and/or data that may cause or enable the event processing computing platform 110 to generate a single-use event processing token for use in processing an event. As discussed herein, the single-use event processing token may be used to process an event from an anonymous event processing source and may include secure mapping information mapping the anonymous event processing source to a user event processing source. The mapping may only be discernable to the event processing computing platform 110 (e.g., only the entity implementing the event processing computing platform 110 may be able to identify the user event processing source via the mapping. The vendor or other party will not have access to that information, thereby maintaining the anonymity and privacy of the user requesting the event).

Event processing computing platform 110 may further have, store and/or include an event processing module 112e. The event processing module 112e may store instructions and/or data that may cause or enable the event processing computing platform 110 to process a requested event (and implement any identified rules) using an anonymous event processing source. Accordingly, the vendor or other party might not receive any information identifying a user requesting the event (e.g., making a purchase). Thus, the user can maintain anonymity with the vendor, protect personal and private information by controlling distribution of the information, and avoid providing purchasing or other behavioral information to the vendor. Rather, only the entity implementing the event processing computing platform 110 may receive and/or access that information. Processing an event may further including reconciling the event with a user event processing source based on the generated mapping.

Event processing computing platform 110 may further have, store and/or include a block chain module 112f. Block chain module 112f may store instructions and/or data that may cause or enable the event processing computing platform 110 to write event processing information to a block chain associated with a user. In some examples, data identifying the user may be stored separately from the event data (e.g., items purchased, amount spent, or the like). Accordingly, block chain data may be used to identify behaviors, monitor trends, and the like, in anonymous data without a user providing any personal information or personally identifying information. The block chain data may be aggregated and used with one or more machine learning processes to evaluate customer behaviors, identify incentives, monitor trends in events, and the like.

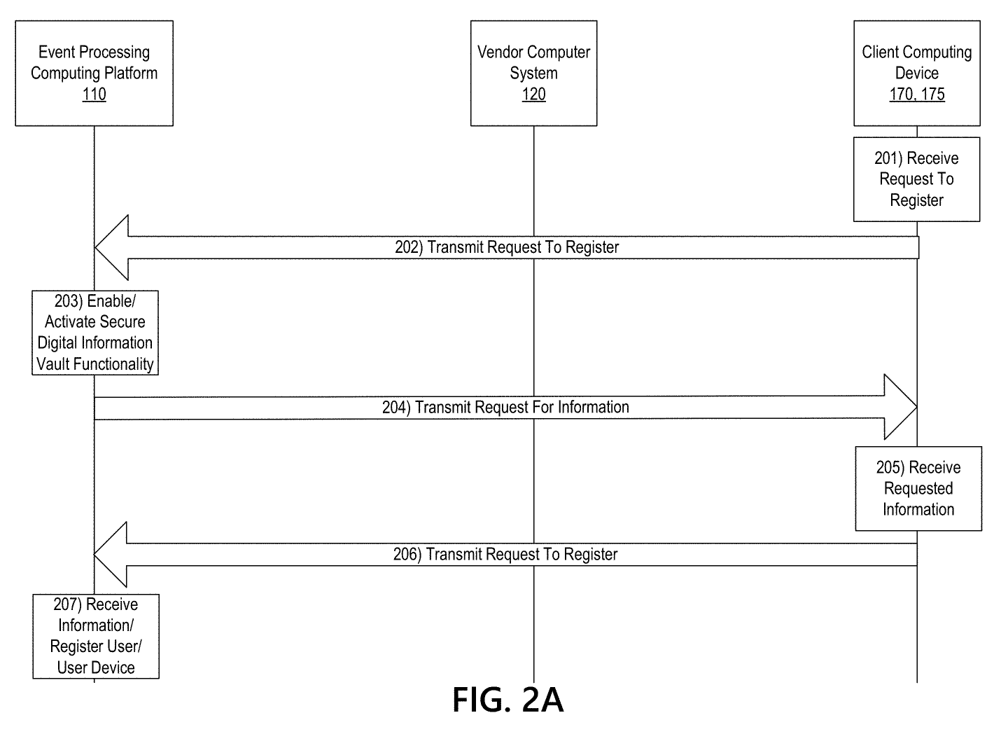

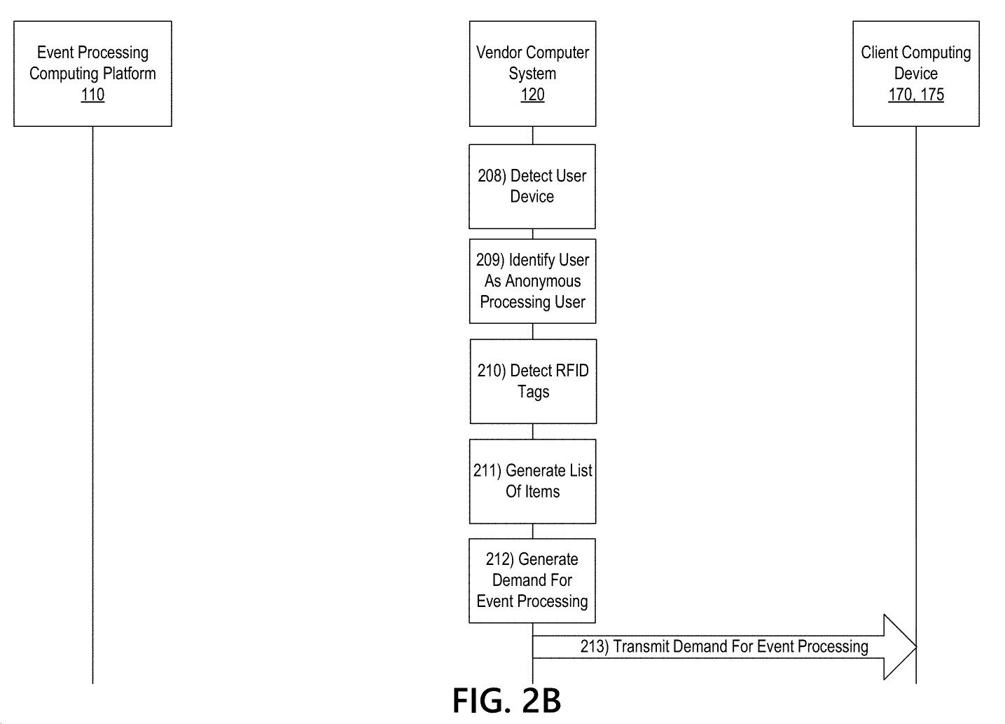

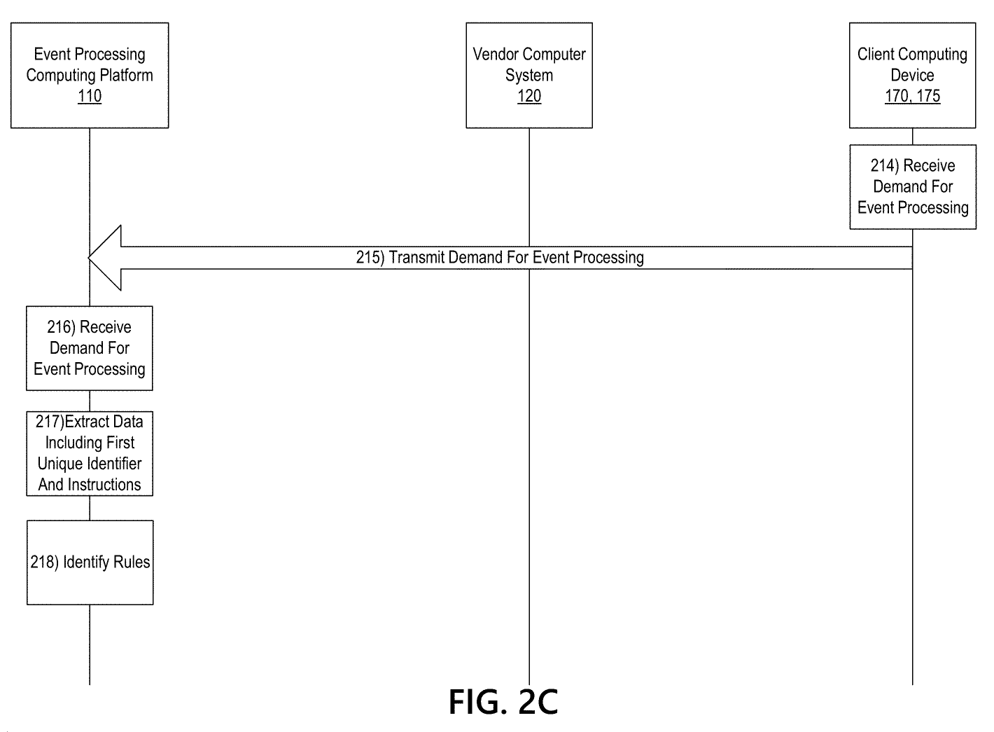

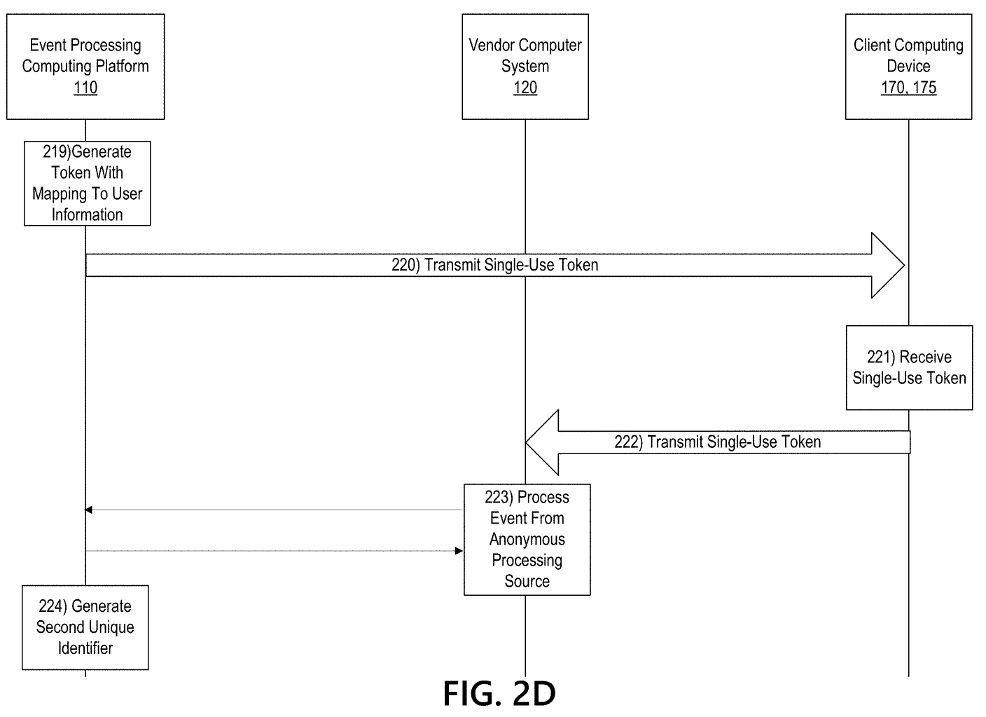

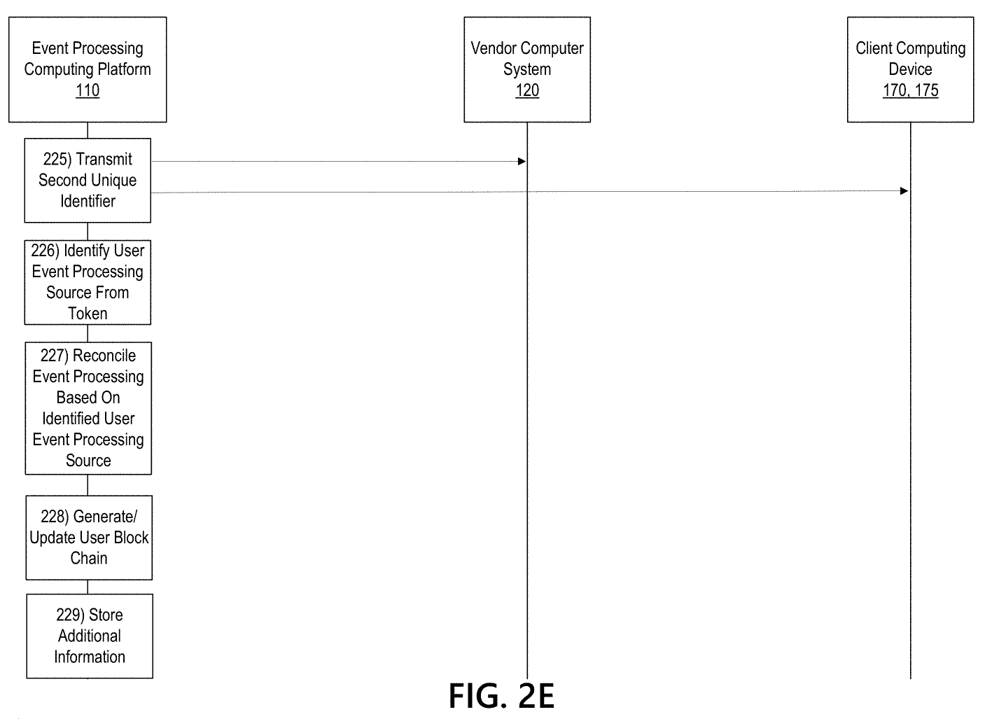

FIGS. 2A-2E depict an illustrative event sequence for implementing and using anonymous event processing functions in accordance with one or more aspects described herein. The events shown in the illustrative event sequence are merely one example sequence and additional events may be added, or events may be omitted, without departing from the invention.

Referring to FIG. 2A, at step 201, a request to register a user and/or device with a secure digital information vault may be received by a client computing device 170. In some examples, the request to register may be made via an application downloaded or otherwise provided on the client computing device and executing on the client computing device 170. At step 202, the request may be transmitted to the event processing computing platform 110. At step 203, one or more functions associated with secure digital information vault functionality may be enabled or activated (e.g., based on receiving the request to register).

At step 204, a request for additional information may be transmitted to the client computing device 170. In some examples, the request may include a request for a user name, user event processing source or sources, a user device identifier, user contact information, government issued photographic identification, and the like. In some examples, additional information such as credit report, credit score, information associated with other members of the user's household, and the like, may be requested. This information, when provided, will be held securely in a digital information vault maintained by the entity implementing the event processing computing platform 110. In some examples, the secure digital information vault may be part of the event processing computing platform 110, such as part of the client information database 112c, block chain module 112f, or the like. In some examples, a user providing a user device identifier may constitute permission by the user for the event processing computing platform to access data stored on the device, such as location data (e.g., global positioning system data), and the like.

At step 205, the request for information may be received and the requested information may be received by the client computing device 170. At step 206, the received user information may be transmitted to the event processing computing platform 110.

At step 207, the requested information may be received by the event processing computing platform 110 and a user record may be generated. The user record may then be populated with information provided by the user in order to register the user and enable anonymous event processing functionality.

With reference to FIG. 2B, at step 208, a user device, such as client computing device 170, may be detected by, for example, a vendor computing system 120. In some examples, a user device may be detected via near-field communication, Bluetooth communication, or the like. In some arrangements, a use device may be detected upon entering a location of a vendor or merchant, upon approaching a service desk to process an event (e.g., make a purchase), or the like. At step 209, the vendor computing system 120, upon detecting the user device, may identify whether the device is associated with anonymous event processing. For instance, the vendor computing system 120 may detect a signal transmitted from the client computing device 170 indicating that the user has anonymous event processing functionality enabled. This may provide a level of confidence for the vendor prior to engaging in an event with the user. In some examples, the vendor computing system 120 may generate and/or transmit the client computing device 170 one or more incentives, discounts, or the like, based on having anonymous event processing functionality enabled.

At step 210, in some examples, the vendor computing system 120 may detect one or more RFID tags associated with items a user is attempted to procure. For instance, each item may have an RFID associated with it. In some examples, the RFID tag may be used to track the item from manufacture through sale. For instance, the RFID tag associated with each item may enable write-only information to be added as the object passes through a distribution system from manufacture through sale. For instance, the RFID tag may include information such as manufacturer identifier, stock keeping unit (SKU), lot number, serial number, make, model, date of manufacture, date of tagging, shipper, shipping date, receiving entity, receiving date, store inventory identifier, and the like. The RFID tag may also include a cost of each item and may be used to determine an overall cost to the user to process an event (e.g., make a purchase, complete a transaction, or the like).

At step 211, a list of items associated with the event being processed and associated cost of each item may be generated. In some examples, the list of items may be generated from the RFID tags associated with each item. In other examples, the vendor computing system 120 may generate the list based on scanning a machine readable code (e.g., quick response (QR) code, bar code, or the like), manually entry of the items and associated costs, or the like.

At step 212, a request or demand for event processing (e.g., payment of a total cost associated with the items) may be generated. The request or demand may include an amount associated with the event, a first unique identifier associated with the event, instructions for transmitting funds to an account of the vendor, and the like. In some examples, the request may be encrypted and, upon detecting the client computing device 170 within proximity of the vendor computing system 120, (e.g., based on near-field communication, global positioning system (GPS) data of the client computing device 170, or the like), may be transmitted to the client computing device 170 at step 213.

With reference to FIG. 2C, at step 214, the request for event processing may be received by the client computing device 170. Upon receive of the request, the client computing device 170 may transmit a request for event processing to the event processing computing platform 110 at step 215. In some examples, the client computing device 170 may decrypt the request prior to transmitting the request to the event processing computing platform 110.

At step 216, the request or demand for event processing may be received by the event processing computing platform 110. In some examples, the request may include location data (e.g., global positioning system data or the like) from the vendor computing system 120 and the client computing device 170 to confirm that the client computing device 170 and vendor computing system 120 are at a same or similar location. This may aid in preventing unauthorized use of the system. At step 217, data may be extracted from the request. For instance, data such as the first unique identifier associated with the event, amount associated with the event, instructions for crediting a vendor account for the event, and the like, may be extracted.

At step 218, one or more rules to apply to the event processing may be identified. For instance, if an amount of the event is above a predetermined threshold, a particular anonymous or user event processing source may be identified for use in processing the event.

With reference to FIG. 2D, at step 219, a single-use event processing token may be generated for use in processing the event. As discussed herein, the single-use event processing token may include an anonymous event processing source from which to transfer funds to the vendor account. The single-use event processing token may also include mapping data mapping the anonymous event processing source to a user event processing source. As discussed herein, the mapping may only be discernable to an entity operating or implementing the event processing computing platform 110. In at least some examples, the vendor computing system 120 might not be able to access use information, user event processing source information, or the like, based on the mapping in the single-use event processing token. Additionally or alternatively, in some examples, the one or more identified rules may be identified prior to generating the single-use event processing token and the single-use event processing token may include the identified one or more rules.

At step 220, the single-use event processing token may be transmitted to the client computing device 120. At step 221, the single-use event processing token may be received by the client computing device 170 and transmitted to the vendor computing system 120 at step 222. In some examples, prior to transmitting the token to the vendor computing system 120, the client computing device 170 may encrypt the token.

At step 223, the single-use event processing token may be received by the vendor computing system 120 and may be used to process the requested event. In some examples, the vendor computing system 120 may decrypt the token prior to processing the event. Processing the requested event may include generating an instruction to process the event based on the single-use event processing token and transmitting and receiving data (e.g., including the generated instruction) between the vendor computing system 120 and the event processing computing platform 110. In some examples, the data may be transmitted and received directly between the vendor computing system 120 and the event processing computing platform 110. In other examples, the data may be transmitted to the client computing device 170 and transmitted on to the event processing computing platform 110 and/or the vendor computing system 120. Processing the event may include executing an instruction to transfer funds from an anonymous payment source to the vendor account in order to provide payment to the vendor.

At step 224, a second unique identifier or confirmation may be generated by the event processing computing platform 110. The second unique identifier may include an indication that the event was processed.

With reference to FIG. 2E, at step 225, the second unique identifier may be transmitted to the vendor computing system 120 and the client computing device 170. Accordingly, each device or system may receive an indication that the event was processed.

At step 226, the even processing computing platform 110 may identify, from the mapping associated with the single-use token, the user event processing source from which funds should be transferred to reconcile the event. At step 227, the event may be reconciled by executing an instruction to transfer funds from the user event processing source to the anonymous event processing source. In some examples, the reconciling may be performed as events are processed. In other examples, reconciling may be performed as a batch process and several events may be collected and reconciled together in a batch process. In some examples, the batch process may occur at a predetermined time (e.g., at 11:00 p.m. eastern standard time, or the like) or may occur at predetermined time intervals (e.g., every 24 hours, or the like). In some examples, after reconciling the event, the single-use token may be disabled or deleted. Accordingly, the single-use token might not be available for additional use after the event is reconciled.

At step 228, a user block chain ledger may be generated and/or updated. For instance, each user may have a block chain associated with him or her. If one does not exist, upon use of the anonymous event processing functionality, a new block chain may be created for the user. As a user uses the anonymous event processing functionality, a record of events processed may be written to the block chain. In some examples, user identifying information may be stored separately from purchase information, and the like. Accordingly, purchase information (e.g., items purchased, cost, and the like), and the like, may be provided to data analysts, may be used by one or more entities, or the like, to monitor purchasing behaviors, track historical purchases, determine user behaviors (e.g., using machine learning), and the like.

In some examples, the block chain for each user may include metadata attributes associated with characteristics of the user, such as hometown, annual income, and the like, without providing information sufficient to identify the user. Data from a plurality of users may be aggregated and one or more machine learning algorithms may be used to analyze this data, predict user behaviors, and the like. A user may request to not participate in this metadata machine learning pool.

At step 229, additional information may be stored. For instance, event details such as items purchased, cost, vendor, and the like, may be stored (instead of or in addition to block chain data) in a client information database 112c. In some examples, only the entity implementing the event processing computing platform 110 may access the client information database 112c. However, users may elect to share anonymized versions of the data (e.g., purchase history, and the like) with one or more other entities.

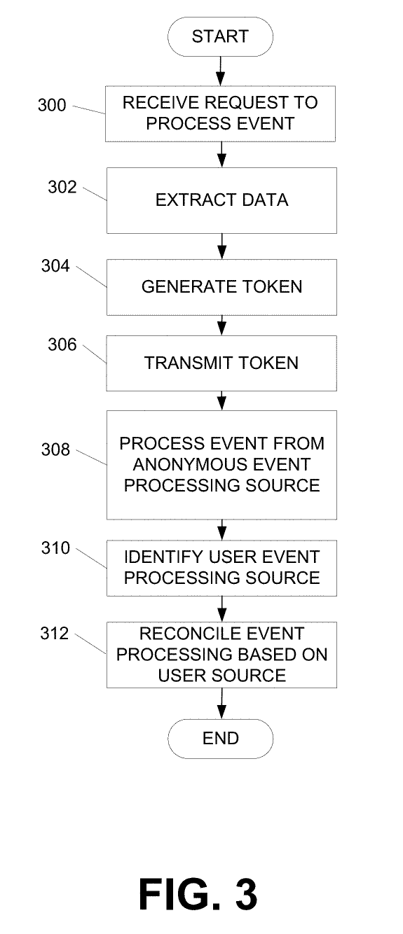

FIG. 3 is a flow chart illustrating one example method of implementing anonymous event processing functions according to one or more aspects described herein. The processes illustrated in FIG. 3 are merely some example processes and functions. The steps shown may be performed in a different order, more steps may be added, or one or more steps may be omitted without departing from the invention.

In step 300, a request to process an event may be received. For instance, an event processing computing platform 110 may receive a request to process an event from a client computing device 170. In some examples, the request to process the event may include data associated with the event (e.g., items, cost, and the like), a unique identifier associated with the event, instructions for a destination to which funds should be transferred, and the like.

At step 302, data may be extracted from the request. For instance, the event processing computing platform 110 may extract data associated with the amount or cost, destination to which funds should be transferred, and the like. At step 304, a token may be generated. In some examples, the token may include data mapping an anonymous event processing source to a user event processing source that may only be discernable (e.g., read by) the event processing computing platform 110. For instance, other computing devices, such as a vendor computing system 120, might not be able to discern the mapping and/or identify the user or user event processing source.

In step 306, the generated token may be transmitted to the client computing device 170. The client computing device 170 may then transmit the generated token to the vendor computing system 120. In some examples, the token may be in the form of a data glyph, machine readable code, or the like, that may be provided to the vendor computing system 120 via a display on the client computing device 170. In other examples, the token may be transmitted from the client computing device 170 to the vendor computing system 120 via near-field communication.

At step 308, the requested event may be processed (e.g., data (such as an instruction to process the event) may be transmitted and received between the vendor computing system 120 and the event processing computing platform 110 to process the event) from the anonymous event processing source. Accordingly, by using the anonymous event processing source, user information might not be transmitted to the vendor. Accordingly, the vendor may not access user information, personal information, store purchase information for the user, or the like.

At step 310, the event processing computing platform 110 may identify the user event processing source from the mapping in the generated token and, at step 312, the event processing computing platform 110 may reconcile the event by transferring funds from the user event processing source to the anonymous event processing source.

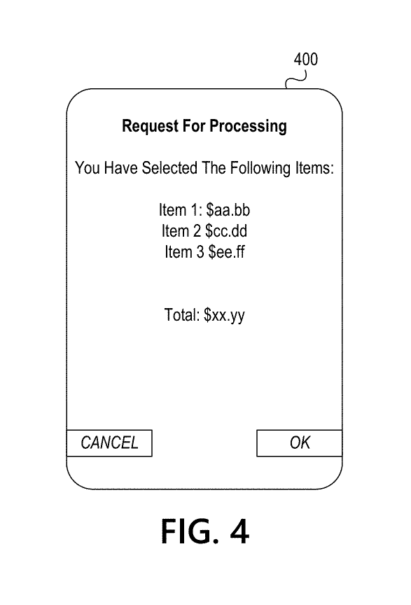

FIG. 4 illustrates one example user interface that may be used with anonymous event processing functionality in accordance with one or more aspects described herein. The interface 400 includes a request or demand of event processing that may be displayed on the client computing device 170 as received from, or based on a signal, command or instruction received from, the vendor computing system 120. The interface 400 includes a list of items associated with the event. As discussed above, the list of items may be generated from RFID tags associated with each item, from scanning a machine readable code associated with each item, via manual entry, or the like. A total amount associated with the list of items may also be displayed.

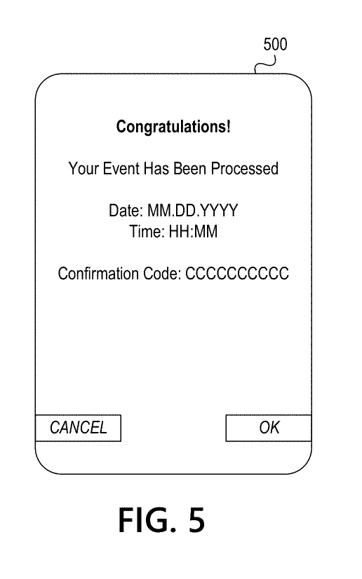

FIG. 5 illustrates another example user interface that may be used with anonymous event processing functionality in accordance with one or more aspects described herein. The interface 500 may include an indication that an event has been processed. The interface 500 may be displayed on a client computing device 170 and may include details of the event, as well as a unique identifier (e.g., confirmation code, or the like) associated with processing the event.

As discussed herein, arrangements described provide for anonymous event processing which aids in maintaining privacy of users, user information, and the like. User information, such as name, account numbers, and the like, may be maintained in a secure digital information vault maintained or controlled by an entity associated with an event processing computing platform. In some examples, the entity may be a financial institution and the financial institution may control access to the user information.

In some examples, a vendor, service provider, or the like, at which a user is attempting to process an event may receive no user-specific information to process the event. Rather, the event may be processed via a single-use event processing token associated with an anonymous event processing source, thereby cloaking the identity of the user. In some examples, the single-use event processing token may including a mapping from the anonymous event processing source to a user event processing source. However, the mapping may be readable only by the event processing computing platform and might not be readable by the vendor computing system.

After an event is processed, the event may be reconciled by transferring funds from the user event processing source to the anonymous event processing source. Details of the event may, in some examples, be written to a user block chain. For instance, event details from each event processed for the user may be recorded in a write-only block chain with a value of the block chain as a machine learning data source separated from the identifying relationship with any individual. For instance, only the entity maintaining the secure digital information vault and implementing the event processing computing platform would have access to information associating one or more of the various block chains associated with a plurality of users to the user associated therewith.

In some examples, as more events are processed using the anonymous event processing functionality described, and more data is written to a user's block chain, the greater the confidence of the entity providing the service in the user. This may translate into additional incentives for the user.

In some example arrangements, a user event processing source need not originate from the same entity as the anonymous event processing source. For instance, a first financial institution may maintain the secure digital information vault and may implementing the event processing computing platform. However, a user event processing source may be associated with a second, different financial institution. The mapping data may then include additional information, such as a routing number, or other information identifying the second financial institution.

Additionally or alternatively, a confidence rating may be generated for users having event processing sources associated with financial institutions other than the first financial institution. In some examples, each financial institution may provide a rating for each user. In some examples, the rating system may be universally applied such that each financial institution implements the same standards or rating factors. This rating may be provided to the user and the entity implementing the secure digital information vault and may be used to generate rules associated with event processing for the user. For instance, users with low ratings (e.g., new customers, customers with little or no credit history, or the like) may be authorized to process events below a threshold amount, while customers with higher ratings may be authorized to process events having amounts higher than the threshold.

In some examples, a user may receive a receipt for a processed event. The receipt may include details of the event. However, in some examples, the vendor would not receive the data associated with the event, thereby preventing the merchant from storing purchase information associated with the event. In some examples, an additional token may be generated in the receipt that may be used to facilitate return of an item, if desired. Similar to the arrangements discussed above, the token would include the anonymous event processing source which would be credited by the vendor, and the return event would later be reconciled (via mapping data) by transferring funds credited from the anonymous event processing source to the user event processing source.

In some arrangements, the systems described herein may also be used in support of other types of event processing. For instance, if a user is applying for insurance or a new job, the entity maintaining the secure digital information vault may receive a request for data from the insurance provider, potential employers, and the like. The entity may evaluate the requesting party and provide a privacy score indicating whether the entity meets predetermined standards for protecting personally identifying information. The user may use this privacy score to determine whether to permit access to his or her personal information.

In some examples, enrollment in the secure digital information vault may provide authenticating information outside of event processing. For instance, systems that rely on other types of authentication (e.g., access to a building, or the like) may detect the mobile device of the user and detect an indication of enrollment in the secure digital fault functionality, which may provide an additional factor in authenticating a user.

As discussed herein, the arrangements described provide for a secure, central repository for user information. In addition, the arrangements enable processing of events without providing access to the user information held in the secure digital information repository and, instead, permits a user to maintain anonymity and control of personally identifying information.

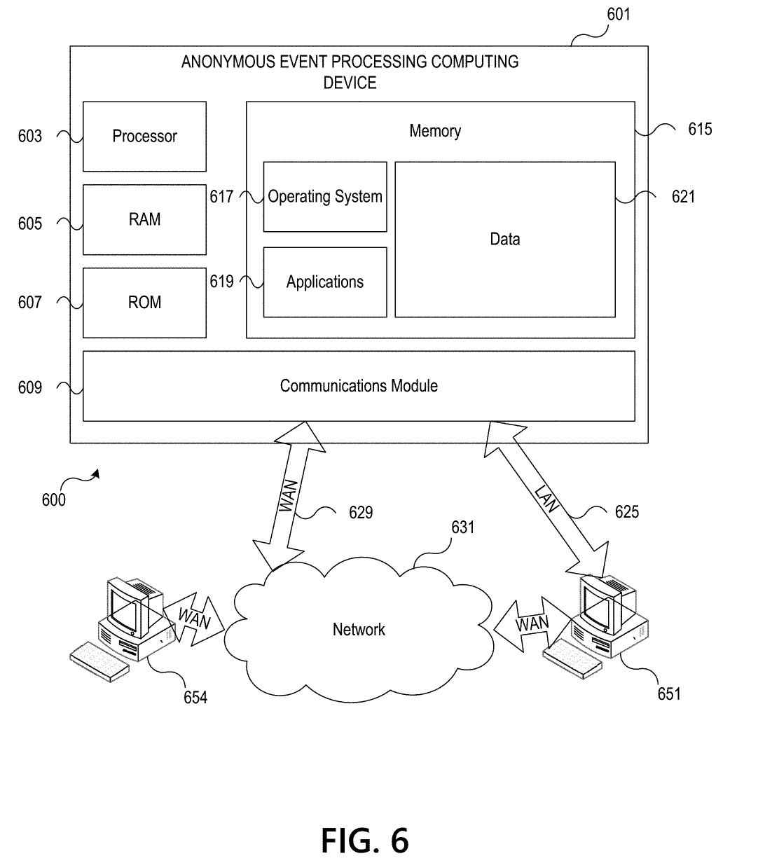

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include anonymous event processing computing device 601 having processor 603 for controlling overall operation of anonymous event processing computing device 601 and its associated components, including Random Access Memory (RAM) 605, Read-Only Memory (ROM) 607, communications module 609, and memory 615. Anonymous event processing computing device 601 may include a variety of computer readable media. Computer readable media may be any available media that may be accessed by anonymous event processing computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on anonymous event processing computing device 601. Such a processor may execute computer-executable instructions stored on a computer-readable medium.

Software may be stored within memory 615 and/or storage to provide instructions to processor 603 for enabling anonymous event processing computing device 601 to perform various functions as discussed herein. For example, memory 615 may store software used by anonymous event processing computing device 601, such as operating system 617, application programs 619, and associated database 621. Also, some or all of the computer executable instructions for anonymous event processing computing device 601 may be embodied in hardware or firmware. Although not shown, RAM 605 may include one or more applications representing the application data stored in RAM 605 while anonymous event processing computing device 601 is on and corresponding software applications (e.g., software tasks) are running on anonymous event processing computing device 601.

Communications module 609 may include a microphone, keypad, touch screen, and/or stylus through which a user of anonymous event processing computing device 601 may provide input, and may also include one or more of a speaker for providing audio output and a video display device for providing textual, audiovisual and/or graphical output. Computing system environment 600 may also include optical scanners (not shown).

Anonymous event processing computing device 601 may operate in a networked environment supporting connections to one or more remote computing devices, such as computing devices 641 and 651. Computing devices 641 and 651 may be personal computing devices or servers that include any or all of the elements described above relative to anonymous event processing computing device 601.

The network connections depicted in FIG. 6 may include Local Area Network (LAN) 625 and Wide Area Network (WAN) 629, as well as other networks. When used in a LAN networking environment, anonymous event processing computing device 601 may be connected to LAN 625 through a network interface or adapter in communications module 609. When used in a WAN networking environment, anonymous event processing computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

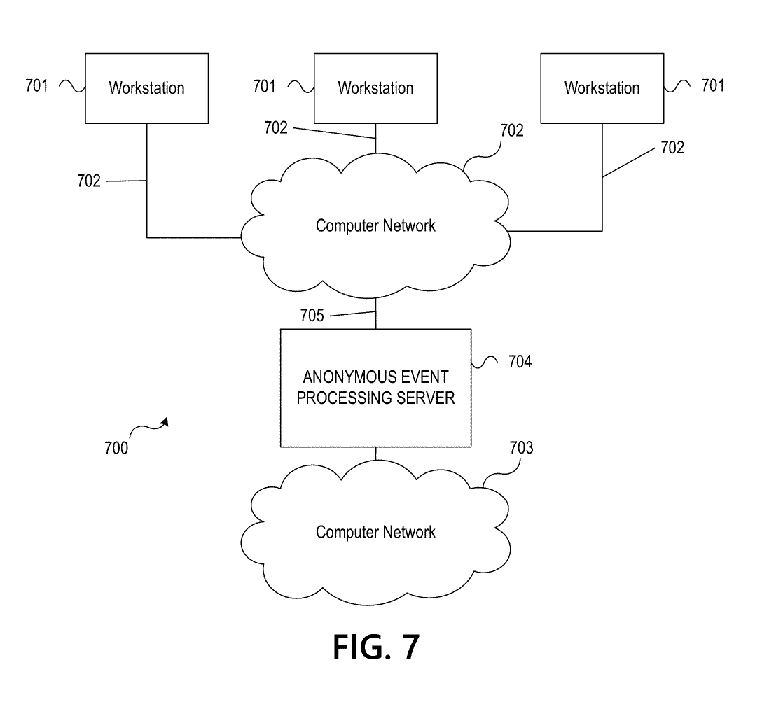

FIG. 7 depicts an illustrative block diagram of workstations and servers that may be used to implement the processes and functions of certain aspects of the present disclosure in accordance with one or more example embodiments. Referring to FIG. 7, illustrative system 700 may be used for implementing example embodiments according to the present disclosure. As illustrated, system 700 may include one or more workstation computers 701. Workstation 701 may be, for example, a desktop computer, a smartphone, a wireless device, a tablet computer, a laptop computer, and the like, configured to perform various processes described herein. Workstations 701 may be local or remote, and may be connected by one of communications links 702 to computer network 703 that is linked via communications link 705 to anonymous event processing server 704. In system 700, anonymous event processing server 704 may be a server, processor, computer, or data processing device, or combination of the same, configured to perform the functions and/or processes described herein. Server 704 may be used to receive requests to process events, generate a token, process and event, transmit unique identifiers, reconcile events, and the like.

Computer network 703 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 702 and 705 may be communications links suitable for communicating between workstations 701 and anonymous event processing server 704, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. An event processing computing platform, comprising:
at least one processor;
a communication interface communicatively coupled to the at least one processor; and
memory storing computer-readable instructions that, when executed by the at least one processor, cause the event processing computing platform to:
receive a request for processing an event from a client computing device;
extract data from the request for event processing, the extracted data including instructions for processing the event and a first unique identifier for use in processing the event;
generate a single-use event processing token, the single-use event processing token including a mapping of an anonymous event processing source to a user event processing source, the mapping being readable by the event processing computing platform;
transmit the single-use event processing token to a computing system;
receive, from the computing system, an instruction to process the event, the instruction being generated based on the single-use event processing token;
based on the received instruction to process the event and the single-use event processing token, anonymously process the event, anonymously processing the event including:
executing an instruction to transfer funds from the anonymous event processing source to a vendor event processing source; and
after executing the instruction to transfer funds from the anonymous event processing source to the vendor processing source, reconciling the event by:
identifying the user event processing source; and
executing an instruction to transfer funds from the user event processing source to the anonymous event processing source.

2. The event processing computing platform of claim 1, further including instructions that, when executed, cause the event processing computing platform to:
after reconciling the event, writing event details to an anonymous user block chain, the anonymous user block chain storing non-identifiable user information separately from purchase information.

3. The event processing computing platform of claim 1, wherein the mapping of the anonymous event processing source to the user event processing source is only readable by the event processing computing platform.

4. The event processing computing platform of claim 1, wherein, prior to receiving the request for event processing, the event is initiated via near-field communication between the computing system and the client computing device.

5. The event processing computing platform of claim 1, further including instructions that, when executed, cause the event processing computing platform to:
prior to generating the single-use event processing token, identify one or more rules to apply to the event processing.

6. The event processing computing platform of claim 5, wherein the generated single-use event processing token includes the identified one or more rules.

7. The event processing computing platform of claim 1, wherein the single-use event processing token does not include any information identifying a user associated with the client computing device.

8. The event processing computing platform of claim 1, wherein anonymously processing the event further includes instructions that, when executed, cause the event processing computing platform to:
generate a second unique identifier indicating the event has been processed; and
transmit the second unique identifier to the computing system and the client computing device.

9. A method, comprising:
at a computing platform comprising at least one processor, memory, and a communication interface:
receiving, by the at least one processor and via the communication interface, a request for processing an event from a client computing device;
extracting, by the at least one processor, data from the request for event processing, the extracted data including instructions for processing the event and a first unique identifier for use in processing the event;
generating, by the at least one processor, a single-use event processing token, the single-use event processing token including a mapping of an anonymous event processing source to a user event processing source, the mapping being readable by the event processing computing platform;
transmitting, by the at least one processor and via the communication interface, the single-use event processing token to a computing system;
receiving, by the at least one processor and from the computing system via the communication interface, an instruction to process the event, the instruction being generated based on the single-use event processing token;
based on the received instruction to process the event and the single-use event processing token, anonymously process, by the at least one processor, the event, anonymously processing the event including:
executing an instruction to transfer, by the at least one processor, funds from the anonymous event processing source to a vendor event processing source; and
after executing the instruction to transfer funds from the anonymous event processing source to the vendor processing source, reconciling, by the at least one processor, the event by:
identifying, by the at least one processor, the user event processing source; and
executing, by the at least one processor, an instruction to transfer funds from the user event processing source to the anonymous event processing source.

10. The method of claim 9, further including:
after reconciling the event, writing event details to an anonymous user block chain, the anonymous user block chain storing non-identifiable user information separately from purchase information.

11. The method of claim 9, wherein the mapping of the anonymous event processing source to the user event processing source is only readable by the event processing computing platform.

12. The method of claim 9, wherein, prior to receiving the request for event processing, the event is initiated via near-field communication between the computing system and the client computing device.

13. The method of claim 9, further including:
prior to generating the single-use event processing token, identifying, by the at least one processor, one or more rules to apply to the event processing.

14. The method of claim 13, wherein the generated single-use event processing token includes the identified one or more rules.

15. The method of claim 9, wherein the single-use event processing token does not include any information identifying a user associated with the client computing device.

16. The method of claim 9, wherein anonymously processing the event further includes:
generate a second unique identifier indicating the event has been processed; and
transmit the second unique identifier to the computing system and the client computing device.

17. One or more non-transitory computer-readable media storing instructions that, when executed by a computing platform comprising at least one processor, memory, and a communication interface, cause the computing platform to:
receive a request for processing an event from a client computing device;
extract data from the request for event processing, the extracted data including instructions for processing the event and a first unique identifier for use in processing the event;
generate a single-use event processing token, the single-use event processing token including a mapping of an anonymous event processing source to a user event processing source, the mapping being readable by the event processing computing platform;
transmit the single-use event processing token to a computing system;
receive, from the computing system, an instruction to process the event, the instruction being generated based on the single-use event processing token;
based on the received instruction to process the event and the single-use event processing token, anonymously process the event, anonymously processing the event including:
executing an instruction to transfer funds from the anonymous event processing source to a vendor event processing source; and
after executing the instruction to transfer funds from the anonymous event processing source to the vendor processing source, reconciling the event by:
identifying the user event processing source; and
executing an instruction to transfer funds from the user event processing source to the anonymous event processing source.

18. The one or more non-transitory computer-readable media of claim 17, further including instructions that, when executed, cause the computing platform to:
after reconciling the event, writing event details to an anonymous user block chain, the anonymous user block chain storing non-identifiable user information separately from purchase information.

19. The one or more non-transitory computer-readable media of claim 17, wherein the mapping of the anonymous event processing source to the user event processing source is only readable by the event processing computing platform.

20. The one or more non-transitory computer-readable media of claim 17, wherein, prior to receiving the request for event processing, the event is initiated via near-field communication between the computing system and the client computing device.

21. The one or more non-transitory computer-readable media of claim 17, further including instructions that, when executed, cause the event processing computing platform to:
prior to generating the single-use event processing token, identify one or more rules to apply to the event processing.

22. The one or more non-transitory computer-readable media of claim 21, wherein the generated single-use event processing token includes the identified one or more rules.

23. The one or more non-transitory computer-readable media of claim 17, wherein the single-use event processing token does not include any information identifying a user associated with the client computing device.

24. The one or more non-transitory computer-readable media of claim 17, wherein anonymously processing the event further includes instructions that, when executed, cause the computing platform to:
generate a second unique identifier indicating the event has been processed; and
transmit the second unique identifier to the computing system and the client computing device.
